(19) United States
(12) Patent Application Publication
(10) Pub. No.: US 2025/0311782 A1
(43) Pub. Date: Oct. 9, 2025

(54) AEROSOL GENERATION DEVICE

(71) Applicant: SMOORE INTERNATIONAL HOLDINGS LIMITED, George Town (KY)

(72) Inventor: Zutao JIN, Shenzhen (CN)

(21) Appl. No.: 19/242,286

(22) Filed: Jun. 18, 2025

Related U.S. Application Data
(63) Continuation of application No. PCT/CN2023/115472, filed on Aug. 29, 2023.

(30) Foreign Application Priority Data
Dec. 19, 2022 (CN) 202211633966.X

(51) Int. Cl. A24F 40/46; A24F 7/04; A24F 40/10; A24F 40/42; A24F 40/485; A24F 40/60; H05B 3/00

(52) U.S. Cl. CPC A24F 40/46; A24F 7/04; A24F 40/42; A24F 40/485; A24F 40/60; H05B 3/0071; A24F 40/10

(57) ABSTRACT

An aerosol generation device includes: a housing comprising a side wall and a bottom wall, an accommodation cavity being jointly delimited by the side wall of the housing and the bottom wall of the housing; a heating assembly accommodated in the accommodation cavity, the heating assembly emitting a laser to heat an aerosol generation substrate; and a heat dissipation assembly accommodated in the accommodation cavity, the heat dissipation assembly including a main body member, the main body member including a mounting portion and an abutting portion. The heating assembly is mounted at the mounting portion. The abutting portion is closer to the side wall of the housing than the mounting portion so as to dissipate heat from the heating assembly.

### CROSS-REFERENCE TO PRIOR APPLICATION

This application is a continuation of International Patent Application No. PCT/CN2023/115472, filed on Aug. 29, 2023, which claims priority to Chinese Patent Application No. 202211633966.X, filed on Dec. 19, 2022. The entire disclosure of both applications is hereby incorporated by reference herein.

### FIELD

The disclosure relates to the technical field of atomization, and more specifically, to an aerosol generation device.

### BACKGROUND

Being good for health and high in cost performance, an aerosol generation device, for example, an electronic atomizer, is popular among a large number of users. Generally, an aerosol generation substrate is heated by the aerosol generation device through a heating assembly, so as to generate an aerosol for inhalation by the user. However, when heating the aerosol generation substrate, the heating assembly generates a large amount of heat. If heat from the heating assembly is constantly accumulated without being dissipated, damage to the heating assembly and other components of the aerosol generation device will be caused, and further normal operation of the aerosol generation device will be affected.

### SUMMARY

In an embodiment, the present invention provides an aerosol generation device, comprising: a housing comprising a side wall and a bottom wall, an accommodation cavity being jointly delimited by the side wall of the housing and the bottom wall of the housing; a heating assembly accommodated in the accommodation cavity, the heating assembly being configured to emit a laser to heat an aerosol generation substrate; and a heat dissipation assembly accommodated in the accommodation cavity, the heat dissipation assembly comprising a main body member, the main body member comprising a mounting portion and an abutting portion, wherein the heating assembly is mounted at the mounting portion, and wherein the abutting portion is closer to the side wall of the housing than the mounting portion so as to dissipate heat from the heating assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic perspective view of assembling of an aerosol generation device according to some embodiments of the disclosure;

FIG. 2 is a schematic sectional view of the aerosol generation device shown in FIG. 1;

FIG. 3 is an enlarged schematic diagram of a portion III in the aerosol generation device shown in FIG. 2;

FIG. 4 is a perspective schematic structural diagram of a housing in the aerosol generation device shown in FIG. 1;

FIG. 5 is a perspective schematic exploded view of some structures of the aerosol generation device shown in FIG. 1; and

FIG. 6 is a perspective schematic exploded view of some structures of the aerosol generation device shown in FIG. 1 in another view.

### DETAILED DESCRIPTION

In an embodiment, the present invention provides an aerosol generation device.

The aerosol generation device according to the embodiments of the disclosure includes a housing, a heating assembly, and a heat dissipation assembly. The housing includes a side wall and a bottom wall, where an accommodation cavity is delimited by the side wall of the housing and the bottom wall of the housing jointly. The heating assembly is accommodated in the accommodation cavity, and the heating assembly is used for emitting a laser to heat an aerosol generation substrate. The heat dissipation assembly is accommodated in the accommodation cavity, and the heat dissipation assembly includes a main body member, where the main body member includes a mounting portion and an abutting portion, the heating assembly is mounted at the mounting portion, and the abutting portion is closer to the side wall of the housing than the mounting portion, so as to dissipate heat from the heating assembly.

In some embodiments, the abutting portion abuts against the inner side of the side wall of the housing.

In some embodiments, the aerosol generation substrate is of a cylindrical structure, and the emergent direction of the laser is substantially perpendicular to the extension direction of the aerosol generation substrate.

In some embodiments, the mounting portion includes a mounting side, and the abutting portion includes a first side, a second side, and a third side, where the first side of the abutting portion faces away from the mounting side, the second side of the abutting portion faces away from the third side of the abutting portion, and the mounting side, the second side of the abutting portion, the first side of the abutting portion, and the third side of the abutting portion are connected in sequence.

In some embodiments, the mounting side is dented towards the first side of the abutting portion, so as to form a mounting recess; and the heating assembly includes: a circuit board and one or more laser chips. The circuit board is arranged in the mounting recess. The one or more laser chips are mounted at the circuit board, and the one or more laser chips are used for emitting the laser.

In some embodiments, the first side of the abutting portion is dented towards the mounting side, so as to form an accommodation recess; and the aerosol generation device further includes a function assembly. The function assembly is mounted in the accommodation recess; and the function assembly includes at least one of a button and a light emitting element.

In some embodiments, the mounting side is dented towards the first side of the abutting portion, so as to form a mounting recess; the second side of the abutting portion or the third side of the abutting portion is dented in the direction facing away from the side wall of the housing, so as to form a fixing recess, and the fixing recess communicates with the mounting recess; and the function assembly further includes a flexible circuit board. The flexible circuit board is arranged in the fixing recess and connected to the function assembly.

In some embodiments, the heat dissipation assembly further includes an extension member. The extension member extends from the bottom of the main body member to the bottom wall of the housing and is connected to the bottom wall of the housing, and the extension member is used for conducting heat produced by the heating assembly to the housing.

In some embodiments, the heat dissipation assembly further includes a heat conduction member; where the heat conduction member is arranged between the housing and the main body member, and the heat conduction member is used for conducting heat of the main body member to the housing.

In some embodiments, the heat dissipation assembly further includes a heat conduction member; where the heat conduction member is arranged between the housing and the extension member, and the heat conduction member is used for conducting heat of the extension member to the housing.

In some embodiments, the extension member includes a first sub-portion and a second sub-portion. The first sub-portion extends from the bottom of the main body member to the side at which the heating assembly is located. The second sub-portion extends from the bottom of the first sub-portion towards the bottom wall of the housing, and the first sub-portion, the second sub-portion, and the main body member form a Z-shaped structure.

In some embodiments, the second sub-portion includes a first side and a second side that face away from each other; and the aerosol generation device further includes a mainboard, where the mainboard is mounted at the first side of the second sub-portion.

In some embodiments, the aerosol generation device further includes a power supply, where the power supply is located at the second side of the second sub-portion, and the power supply is electrically connected to the mainboard.

In some embodiments, the aerosol generation device further includes a drive assembly, where the drive assembly is mounted at the first side of the second sub-portion, and the drive assembly is electrically connected to the mainboard.

In some embodiments, the aerosol generation substrate includes a plurality of substrate portions distributed in the peripheral direction; the aerosol generation device further includes a cartridge assembly and an article, where the cartridge assembly is mounted at the first sub-portion and/or the mounting side of the mounting portion, and the article is at least partially accommodated in the cartridge assembly and used for loading the aerosol generation substrate; and the drive assembly is used for driving the article to rotate relative to the cartridge assembly, so as to enable the heating assembly to correspond to different substrate portions.

In some embodiments, the drive assembly includes a drive member and a connection component. The drive member is electrically connected to the mainboard. The connection component passes through the cartridge assembly, an output shaft of the drive member is connected to the article through the connection component, and the drive member is used for driving the article to rotate relative to the cartridge assembly.

In some embodiments, the cartridge assembly includes a support seat and a cartridge barrel. The support seat is mounted at the first sub-portion and/or the mounting side. The cartridge barrel is mounted at the side, facing away from the bottom wall of the housing, of the support seat, the article is at least partially accommodated in the cartridge barrel, the cartridge barrel is provided with a light transmittable region, and the light transmittable region corresponds to the laser chip of the heating assembly.

In some embodiments, the cartridge barrel includes a peripheral wall, one or more mounting supports, and one or more limiting seats. The peripheral wall includes a first end and a second end that face away from each other. The one or more mounting supports extend from the first end of the peripheral wall towards the main body member, and the mounting support is used for connecting the peripheral wall to the main body member. The one or more limiting seats extend from the second end of the peripheral wall towards the main body member, the limiting seat partially extends into the main body member, and the one or more limiting seats are connected to the support seat.

In some embodiments, the support seat includes a carrying board and a protrusion, where the protrusion extends from the carrying board towards the bottom wall of the housing, and the protrusion is connected to the first sub-portion and/or the mounting side; and the aerosol generation device further includes an airflow sensor assembly, where the airflow sensor assembly is arranged at the side, facing away from the mounting side, of the protrusion, and the airflow sensor assembly is used for detecting whether the aerosol generation device is vaped.

In some embodiments, the cartridge assembly and the housing jointly form a device air passage; and the airflow sensor assembly includes an electrical connector and an airflow sensor. The electrical connector is arranged at the side, facing away from the mounting side, of the protrusion. The airflow sensor is arranged at the electrical connector, the electrical connector is provided with a through hole communicating with the device air passage, the airflow sensor covers the through hole, the electrical connector is used for connecting the airflow sensor to the mainboard, and the airflow sensor is used for determining whether the aerosol generation device is vaped according to an air pressure in the device air passage.

In some embodiments, the side wall of the housing is provided with a penetrated-through air inlet hole; and the cartridge assembly further includes a connection base mounted at the support seat; where the support seat is provided with a first channel, the connection seat is provided with a second channel and a communication hole corresponding to and communicating with the air inlet hole, and the second channel, the first channel, the communication hole, and the air inlet hole communicate with one another in sequence, so as to jointly form the device air passage.

In some embodiments, the article includes a support member and the aerosol generation substrate. The support member is at least partially accommodated in a cartridge barrel of the cartridge assembly, the extension direction of the support member is substantially identical to the extension direction of the main body member, and the support member rotates relative to a support seat of the cartridge assembly. The aerosol generation substrate is arranged around the support member, and the aerosol generation substrate is accommodated in the cartridge barrel; where in a case that the support member rotates, the aerosol generation substrate rotates along with the support member. In some embodiments, the support member and the aerosol generation substrate jointly form a plurality of article air passages, each substrate portion is used to delimit one article air passage, and a device air passage of the aerosol generation device communicates with an article air passage delimited by a substrate portion currently heated constantly.

In some embodiments, aerosol generation device further includes a mouthpiece. The support member includes a loading portion, a support frame, and a connection portion. The mouthpiece passes through the loading portion, and the loading portion is at least partially located outside the cartridge barrel. The support frame is connected to the loading portion, the support frame is located in the cartridge barrel, the aerosol generation substrate is arranged around the support frame, and the loading portion communicates with the support frame. The connection portion is connected to the support frame, the connection portion is closer to the bottom wall of the housing than the support frame. The connection portion is detachably connected to a connection seat of the cartridge assembly.

In some embodiments, the loading portion is provided with a penetrated-through hole, the support frame is provided with a plurality of airflow channels, the connection portion is provided with a plurality of penetration holes, each airflow channel corresponds to one penetration hole and the penetrated-through hole, and each airflow channel, the corresponding penetration hole, and the corresponding penetrated-through hole form an article air passage.

In some embodiments, the mouthpiece includes a cooling segment and a filtering segment, where the cooling segment communicates with the filtering segment, the cooling segment passes through the loading portion, the filtering segment is located at one end, facing away from the loading portion, of the cooling segment, and the filtering segment is at least partially located outside the accommodation cavity.

In some embodiments, a stop member is provided at the outer side of the aerosol generation substrate, and the stop member is used for stopping an aerosol generated by the aerosol generation substrate from flowing to the laser chip.

In some embodiments, the top of the housing is provided with an opening; and the aerosol generation device further includes a cover assembly; where the cover assembly includes a fixed component and a movable component. The fixed component is fixedly mounted in the opening and provided with a penetrated-through plug-in hole, and the plug-in hole communicates with the accommodation cavity. The movable component is mounted at the fixed component, and the movable component is movable relative to the fixed component, so as to selectively open or cover the plug-in hole.

In some embodiments, the aerosol generation device further includes a cartridge assembly; where the fixed component includes a first cover member and a second cover member. The first cover member includes a first side and a second side that face away from each other, and a first penetration hole penetrating the first side and the second side, where the first side of the first cover member faces the bottom wall of the housing, and the first cover member covers the opening and is fixedly connected to the cartridge assembly and/or the main body member. The second cover member is arranged at the second side of the first cover member, the first cover member cooperates with the second cover member, so as to form a movement recess, and the second cover member includes a penetrated-through second penetration hole, where the second penetration hole corresponds to the first penetration hole, so as to form the plug-in hole, and the second cover member is fixedly connected to the cartridge assembly and/or the main body member.

In some embodiments, the movable component includes a movable member and a force application member. The movable member is accommodated in the movement recess and movable relative to the fixed component in the movement recess. The force application member is arranged at the side, facing away from the first cover member, of the second cover member, the force application member is connected to the movable member, and the force application member is used for driving the movable member to move along relative to the fixed component, so as to cover or open the plug-in hole

In the aerosol generation device according to the embodiments of the disclosure, the heating assembly is connected to the mounting portion of the main body member, and the abutting portion is closer to the side wall of the housing than the mounting portion. Thus, the heat dissipation assembly can conduct the heat produced by the heating assembly during operation to the housing, so as to dissipate the heat from the heating assembly. Accordingly, damage to the heating assembly and other components of the aerosol generation device caused after the heat produced by the heating assembly is accumulated is prevented, normal operation of the aerosol generation device is ensured.

Additional aspects and advantages of the disclosure will be set forth in part in the following description, and in part will become apparent from the following description, or will be learned by practice of the disclosure.

To make the above objects, features, and advantages of the disclosure more apparent and comprehensible, the detailed description is made to specific embodiments of the disclosure below with reference to the accompanying drawings. In the following description, various specific details are set forth for thorough understanding of the disclosure. However, the disclosure can be implemented in many other ways different from those described herein. Those skilled in the art can make similar improvements without departing from the connotation of the disclosure. Thus, the disclosure is not limited by specific embodiments disclosed below.

In the description of the disclosure, it should be understood that orientation or position relations indicated by the terms such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “anticlockwise”, “axial direction”, “radial direction”, and “peripheral direction” are based on orientation or position relations shown in the accompanying drawings, and are merely used for ease and brevity of the description of the disclosure, rather than indicating or implying that the mentioned device or element must have a particular orientation or must be constructed and operated in a particular orientation. Thus, such terms should not be interpreted as limiting the disclosure.

In addition, the terms “first” and “second” are merely used for the purpose of description, and cannot be interpreted as indicating or implying relative importance or implying a quantity of indicated technical features. Thus, a feature restricted by “first” or “second” can explicitly indicate or implicitly include at least one of such a feature. In the description of the disclosure, “a plurality of” indicates at least two, such as two or three, unless specifically defined otherwise.

In the disclosure, the terms such as “mount”, “connect”, “connection”, and “fix” should be understood in a broad sense, unless explicitly specified and defined otherwise. For example, they can indicate a fixed connection, a detachable connection, or an integral connection; indicate a mechanical connection or an electrical connection; indicate a direct connection or an indirect connection through an intermediate medium; or indicate internal communication between two elements or an interaction relation between two elements, unless explicitly specified otherwise. Those of ordinary skill in the art can understand the specific meanings of the above terms in the disclosure according to specific circumstances.

In the disclosure, in a case that a first feature is “on” or “underneath” a second feature, it can indicate that the first feature is in direct contact with the second feature, or the first feature is in indirect contact with the second feature through an intermediate medium, unless explicitly specified and defined otherwise. Moreover, in a case that the first feature is “on”, “above”, and “over” the second feature, it can indicate that the first feature is exactly above the second feature or not, or merely indicate that the first feature has a higher level than the second feature. In a case that the first feature is “underneath”, “below”, and “under” the second feature, it can indicate that the first feature is exactly below the second feature or not, or merely indicate that the first feature has a lower level than the second feature.

It should be noted that when referred to as “being fixed to” or “being arranged at” another element, an element can be directly on another element, or an intermediate element can be present. When deemed as “being connected to” another element, an element can be directly connected to another element, or an intervening element can be present. The terms such as “perpendicular”, “horizontal”, “upper”, “lower”, “left”, and “right” used herein are merely for the purpose of description, but do not indicate a unique embodiment.

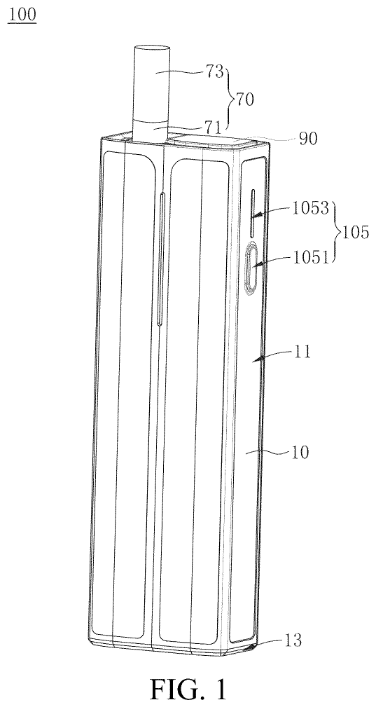

Being good for health and high in cost performance, an aerosol generation device, for example, an electronic atomizer, is popular among a large number of users. Generally, an aerosol generation substrate is heated by the aerosol generation device through a heating assembly, so as to generate an aerosol for inhalation by the user. However, when heating the aerosol generation substrate, the heating assembly generates a large amount of heat. If heat from the heating assembly is constantly accumulated without being dissipated, damage to the heating assembly and other components of the aerosol generation device will be caused, and further normal operation of the aerosol generation device will be affected. To solve the problem, the disclosure provides an aerosol generation device 100 (shown in FIG. 1).

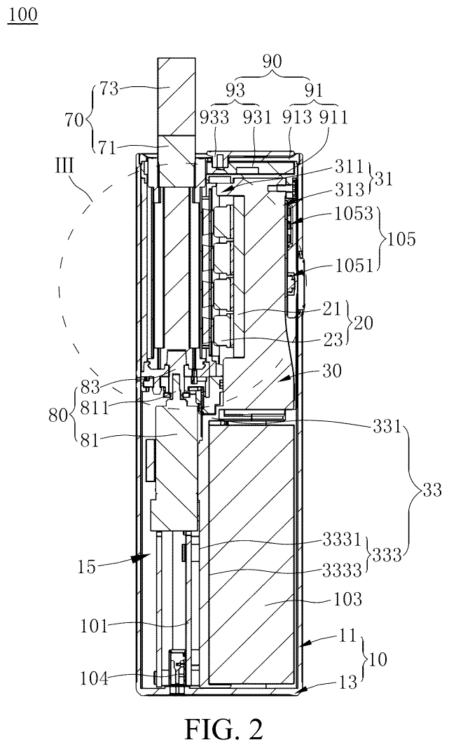

With reference to FIG. 1 and FIG. 2, the aerosol generation device 100 according to the embodiments of the disclosure includes a housing 10, a heating assembly 20, and a heat dissipation assembly 30. The housing 10 includes a side wall 11 and a bottom wall 13, where an accommodation cavity 15 is delimited by the side wall 11 of the housing 10 and the bottom wall 13 of the housing 10 jointly. The heating assembly 20 is accommodated in the accommodation cavity 15, and the heating assembly 20 is used for emitting a laser to heat an aerosol generation substrate 63. The heat dissipation assembly 30 is accommodated in the accommodation cavity 15, and the heat dissipation assembly 30 includes a main body member 31, where the main body member 31 includes a mounting portion 311 and an abutting portion 313, the heating assembly 20 is mounted at the mounting portion 311, and the abutting portion 313 is closer to the side wall 11 of the housing 10 than the mounting portion 311, so as to dissipate heat from the heating assembly 20.

The aerosol generation substrate 63 is an element that can generate an aerosol under the action of heating, ultrasonic waves, mechanical vibration, etc. In some embodiments, the aerosol generation substrate 63 is an atomization medium carrier loaded with e-liquid in liquid form. The e-liquid is a liquid mixture in which nicotine, nicotine, etc. are dissolved, with a common organic solute (such as propylene glycol and vegetable glycerol) and/or organic solute (such as pure water). After heated by the heating assembly 20, the e-liquid is dispersed into tiny mixed liquid droplets, and mixed with air to form the aerosol. In some other embodiments, the aerosol generation substrate 63 is a leaf-type atomization medium. The leaf-type atomization medium volatilizes out tiny solid particles after heated by the heating assembly 20, and mixed with air to form the aerosol.

The heating assembly 20 is of such a structure that can produce heat energy or transfer heat energy to other portions. In some embodiments, the heating assembly 20 can directly convert energy in another form, such as electric energy, chemical energy, and solar energy, into heat energy, and conduct the heat energy to other portions to be heated through heat conduction. In yet some other embodiments, the heating assembly 20 emits out energy in another form, such as an electromagnetic wave, a laser, or heat radiation that can directly act on a surface of a portion to be heated, so as to increase a temperature of a region that receives the electromagnetic wave, the laser, or the heat radiation. For example: in the embodiments of the disclosure, the heating assembly 20 emits out the laser to the aerosol generation substrate 63, and thus the aerosol generation substrate

63 is irradiated with the laser and heated, so as to generate the aerosol. The aerosol generation substrate 63 is heated by a laser chip 23. Thus, the aerosol generation substrate 63 can rapidly produce the aerosol, so that freshness of the aerosol inhaled by a user each time can be ensured.

In the aerosol generation device 100 of the disclosure, the heating assembly 20 is connected to the mounting portion 311 of the main body member 31, and the abutting portion 313 is closer to the side wall 11 of the housing 10 than the mounting portion 311. Thus, the heat dissipation assembly 30 can conduct heat generated by the heating assembly 20 during operation to the housing 10, so as to dissipate the heat from the heating assembly 20. Accordingly, damage to the heating assembly 20 and other components of the aerosol generation device 100 after the heat produced by the heating assembly 20 is accumulated is prevented, and normal operation of the aerosol generation device 100 is ensured.

The aerosol generation device 100 will be further described below with reference to the accompanying drawings.

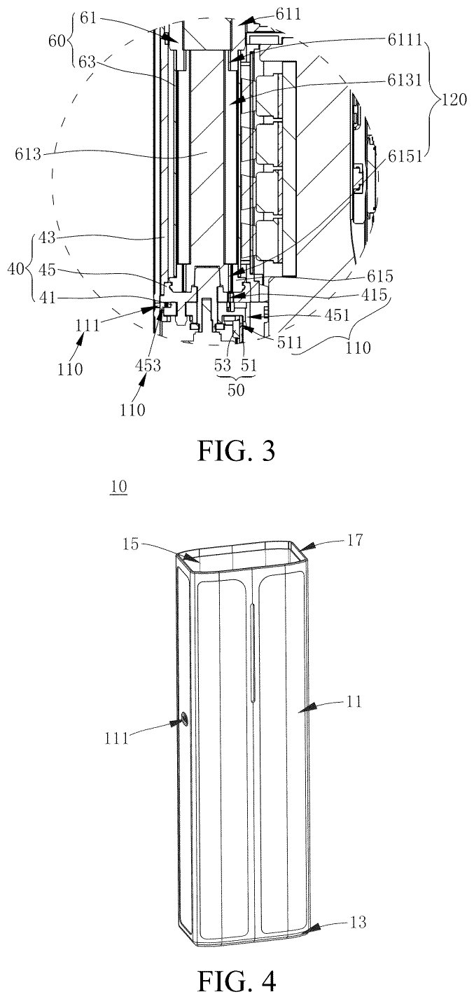

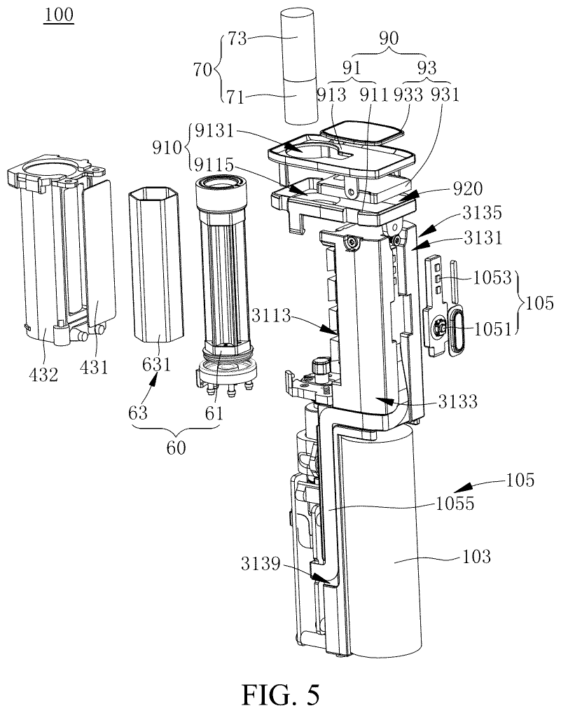

With reference to FIG. 2 and FIG. 3, in some embodiments, the aerosol generation device 100 may further include a cartridge assembly 40, an article 60, and a drive assembly 80. The heating assembly 20, the heat dissipation assembly 30, the cartridge assembly 40, and the drive assembly 80 are arranged in the accommodation cavity 15. The article 60 is at least partially accommodated in the cartridge assembly 40 and used for loading the aerosol generation substrate 63. The heating assembly 20 is used for emitting the laser to heat the aerosol generation substrate 63. The heat dissipation assembly 30 is used for dissipating the heat from the heating assembly 20. The drive assembly 80 is used for driving the article 60 to rotate relative to the cartridge assembly 40, so as to enable the heating assembly 20 to correspond to different substrate portions 631 (shown in FIG. 5).

In conjunction with FIG. 4, in some embodiments, the housing 10 may include the side wall 11 and the bottom wall 13, where the accommodation cavity 15 is delimited by the side wall 11 of the housing 10 and the bottom wall 13 of the housing 10 jointly. In an embodiment, the housing 10 may be made of aluminum alloy, stainless steel, etc., so that a heat dissipation effect on the aerosol generation device 100 can be improved, and the normal operation of the aerosol generation device 100 can be ensured. In another embodiment, a holder may be made of polycarbonate (PC), poly(1,4-cyclohexylene dimethylene terephthalate glycol) (PCTG), etc., so that a weight of the housing 10 can be reduced, and the aerosol generation device 100 can be more lightweight.

In some embodiments, the heating assembly 20 includes a circuit board 21 and one or more laser chips 23. The circuit board 21 is arranged at the heat dissipation assembly 30, and the one or more laser chips 23 are mounted at the circuit board 21 and used for emitting the laser to the aerosol generation substrate 63.

The circuit board 21 is electrically connected to the laser chip 23. The laser chip 23 is used for emitting the laser to the aerosol generation substrate 63, and increasing a temperature of a portion, in contact with the laser, of the aerosol generation substrate 63, so that the aerosol to be inhaled by the user is formed. In an embodiment, the laser chip 23 may be non-detachably fixed to the circuit board 21 through soldering, gluing, interference fitting, etc., which is not limited herein. In another embodiment, the laser chip 23 may be detachably mounted at the circuit board 21 through snapping connection, threaded connection, etc., which is not limited herein. The aerosol generation substrate 63 is heated by a laser chip 23. Thus, the aerosol generation substrate 63 can rapidly produce the aerosol, so that freshness of the aerosol inhaled by a user each time can be ensured. In another embodiment, the heating assembly 20 or may heat the aerosol generation substrate 63 through a plasma based rapid heating method, etc.

In an embodiment, only one laser chip 23 may be arranged. In other words, the aerosol generation substrate 63 is heated by one laser chip 23, so that a production cost can be reduced. In another embodiment, a plurality of laser chips 23 may be arranged. In other words, the aerosol generation substrate 63 is heated by the plurality of laser chips 23 jointly. Thus, aerosol generation efficiency can be improved. Moreover, in a case that some laser chips 23 are damaged, the aerosol generation substrate 63 can still be heated by remaining laser chips 23 normally, so as to generate the aerosol to be inhaled by the user. Thus, stability of operation of the aerosol generation device 100 is ensured.

With reference to FIG. 2, FIG. 3, and FIG. 5, in some embodiments, the aerosol generation substrate 63 is of a cylindrical structure, and the emergent direction of the laser is substantially perpendicular to the extension direction of the aerosol generation substrate 63.

Specifically, the aerosol generation substrate 63 in the cylindrical structure is provided with a plurality of substrate portions 631, and the plurality of substrate portions 631 are distributed in the peripheral direction of the aerosol generation substrate 63 in the cylindrical structure. In a case that the aerosol generation substrate 63 rotates, the heating assembly 20 can correspond to different substrate portions 631 of the aerosol generation substrate 63. In an embodiment, the emergent direction of the laser is perpendicular to the extension direction of the aerosol generation substrate 63. In this case, the distance between the laser and the corresponding substrate portion 631 reachable is the shortest. Thus, heating efficiency of the heating assembly 20 on the corresponding substrate portion 631 can be improved, time required by the aerosol generation substrate 63 to generate the aerosol when the aerosol generation device 100 is vaped can be shortened, immediate stop after vaping can be realized, and vaping experience of the user can be improved. In another embodiment, a small predetermined included angle is formed between the emergent direction of the laser and the extension direction of the aerosol generation substrate 63. For example, the small predetermined included angle is less than or equal to 30°. With the small predetermined included angle, a laser irradiation area can be expanded. Thus, an amount of the aerosol produced after the aerosol generation substrate 63 is heated is ensured, and the mouth feel of vaping is also ensured.

In some embodiments, an outer contour of the substrate portion 631 may be square, circular, etc. which is not limited herein. In an embodiment, areas and outer contours of the plurality of substrate portions 631 of the aerosol generation substrate 63 may be identical. In a case that the aerosol generation substrate 63 rotates, the heating assembly 20 corresponds to different substrate portions 631. With the plurality of identical substrate portions 631, the aerosol generation substrate 63 can rotate by the same angle each time. Thus, a control program for the drive assembly 80 to drive the aerosol generation substrate 63 to rotate can be simplified. In another embodiment, areas or outer contours of the plurality of substrate portions 631 may be different. With the plurality of different substrate portions 631, the aerosol generation device 100 enables the heating assembly 20 to correspond to different substrate portions 631 according to the vaping habit of the user (for example, the user likes to inhale a small quantity of aerosol first and then inhale more aerosols). Thus, too many or too few aerosols produced after the aerosol generation substrate 63 is heated are avoided, and the mouth feel of vaping by the user is ensured.

With reference to FIG. 2, in some embodiments, the heat dissipation assembly 30 may include a main body member 31 and an extension member 33. The main body member 31 is accommodated in the accommodation cavity 15, and the heating assembly 20 is mounted at the main body member 31. The extension member 33 extends from the bottom of the main body member 31 to the bottom wall 13 of the housing 10 and is connected to the bottom wall 13 of the housing 10. The main body member 31 and the extension member 33 are used for conducting the heat produced by the heating assembly 20 to the housing 10.

Specifically, the main body member 31 and the extension member 33 may be made of a material resistant to a high temperature and high in heat conduction speed, for example, polyetheretherketone (PEEK), a high-melting-point metal, and a high-temperature-resistant ceramic, which is not limited herein. The main body member 31 and the extension member 33 at least partially abut against the inner side of the side wall 11 of the housing 10, so as to dissipate heat from the circuit board 21 and the laser chip 23. Thus, damage to the circuit board 21 and the laser chip 23 caused by an excessively-high temperature in an operation process is prevented, and the normal operation and use safety of the aerosol generation device 100 are ensured.

In some embodiments, the main body member 31 may include a mounting portion 311 and an abutting portion 313, where the mounting portion 311 faces the side wall 11 of the housing 10, the heating assembly 20 is mounted at the mounting portion 311, and the abutting portion 313 abuts against the inner side of the side wall 11 of the housing 10, so as to conduct the heat produced by the heating assembly 20 to the housing 10 for heat dissipation. Specifically, the mounting portion 311 includes a mounting side 3111, the abutting portion 313 includes a first side 3131, a second side 3133, and a third side 3135, the first side 3131 of the abutting portion 313 faces away from the mounting side 3111, the second side 3133 of the abutting portion 313 faces away from the third side 3135 of the abutting portion 313, and the mounting side 3111, the second side 3133 of the abutting portion 313, the first side 3131 of the abutting portion 313, and the third side 3135 of the abutting portion 313 are connected in sequence.

The mounting portion 311 faces the side wall 11 of the housing 10, and the heating assembly 20 is mounted at the mounting side 3111. Thus, the emergent direction of the laser of the heating assembly 20 faces the side wall 11 of the housing 10. It should be noted that in some embodiments, the heating assembly 20 and the main body member 31 are arranged in parallel. In other words, in a case that the emergent direction of the laser of the heating assembly 20 faces the side wall 11 of the housing 10, in the emergent direction of the laser, the projection of the heating assembly 20 coincides with the projection of the main body member 31. Thus, a large contact area can be provided between the heating assembly 20 and the main body member 31, a heat dissipation effect of the main body member 31 on the heating assembly 20 can be ensured, and the normal operation of the aerosol generation device 100 can also be ensured.

With reference to FIG. 2 and FIG. 5, in some embodiments, the mounting portion 311 is further provided with a mounting recess 3113. The mounting recess 3113 is dented from the mounting side 3111 towards the first side 3131 of the abutting portion 313, and the circuit board 21 and the laser chip 23 are arranged in the mounting recess 3113. With the mounting recess 3113, the contact area between the main body member 31 and the heating assembly 20 can be expanded in a case that the side wall of the circuit board 21 and/or the side wall of the laser chip 23 are/is in contact with the side wall of the mounting recess 3113, so that the heat dissipation effect can be improved. Moreover, with the mounting recess 3113, a focal length of the laser chip 23 can also be adjusted conveniently, and the heating efficiency of the laser chip 23 on the aerosol generation substrate 63 can be improved. In addition, with the mounting recess 3113, space occupied by the heating assembly 20 can also be reduced, so that the aerosol generation device 100 can be miniaturized. In another embodiment, the circuit board 21 and the laser chip 23 or may be directly mounted at the mounting side 3111 (in other words, no mounting recess 3113 is provided). Thus, a processing technology of the main body member 31 can be simplified, and production efficiency of the heat dissipation assembly 30 can be improved. It should be noted that in some embodiments, the circuit board 21 may be mounted in the mounting recess 3113 through sticking, soldering, snapping, etc.

In some embodiments, the extension member 33 includes a first sub-portion 331 and a second sub-portion 333. The first sub-portion 331 extends from the bottom of the main body member 31 towards the side at which the heating assembly 20 is located. The second sub-portion 333 extends from the bottom of the first sub-portion 331 towards the bottom wall 13 of the housing 10. The first sub-portion 331, the second sub-portion 333, and the main body member 31 form a Z-shaped structure.

Specifically, the second sub-portion 333 extends from the bottom of the first sub-portion 331 to abut against the bottom wall 13 of the housing 10, and the bottom of the second sub-portion 333 is connected to the bottom wall 13 of the housing 10. In a case of projecting towards the bottom wall 13 of the housing 10, the projection of the main body member 31 does not coincide with the projection of the second sub-portion 333, or the projection of the main body member 31 only partially coincides with the projection of the second sub-portion 333, so that the first sub-portion 331, the second sub-portion 333, and the main body member form the Z-shaped structure jointly. With the Z-shaped structure, the main body member 31 and the extension member 33 can be mounted at more mounting positions, for example, the top of the main body member 31, the bottom of the main body member 31, the side surface of the main body member 31, the top of the first sub-portion 331, and the side surface of the second sub-portion 333. Thus, internal space of the aerosol generation device 100 can be rationally utilized, interference between the assemblies can be reduced, and miniaturization can be achieved. Moreover, the contact area between the main body member 31 and the housing 10 and the contact area between the extension member 33 and the housing 10 can be expanded, the heat dissipation effect can be improved, and the normal operation of the aerosol generation device 100 can be ensured.

In some embodiments, the second sub-portion 333 includes a first side 3331 and a second side 3333 that face away from each other. The first side 3331 of the second sub-portion 333 is the side away from the main body member 31, and the second side 3333 of the second sub-portion 333 is the side close to the main body member 31. The aerosol generation device 100 further includes a mainboard 101, and the mainboard 101 is mounted at the first side 3331 of the second sub-portion 333. The mainboard 101 can control activation and deactivation of the heating assembly 20, a heating power of the heating assembly 20, etc.

In some embodiments, the aerosol generation device 100 further includes a power supply 103, where the power supply 103 is located at the second side 3333 of the second sub-portion 333, and the power supply 103 is electrically connected to the mainboard 101. The power supply 103 is used for supplying power to the mainboard 101, the heating assembly 20, and another function assembly 105. The power supply 103 and the mainboard 101 are arranged at the first side 3331 of the second sub-portion 333 and the second side 3333 of the second sub-portion 333 respectively, so as to avoid interference between the power supply 103 and the mainboard 101, between the power supply 103 and another component, and between the mainboard 101 and another component. Thus, a size occupied by the power supply 103 and the mainboard 101 is reduced, and the aerosol generation device 100 is miniaturized. In some embodiments, the aerosol generation device 100 may further include a charging interface 104, where the charging interface 104 is mounted at the mainboard 101 and exposed from the side wall 11 of the housing 10, so that the user can charge the power supply 103.

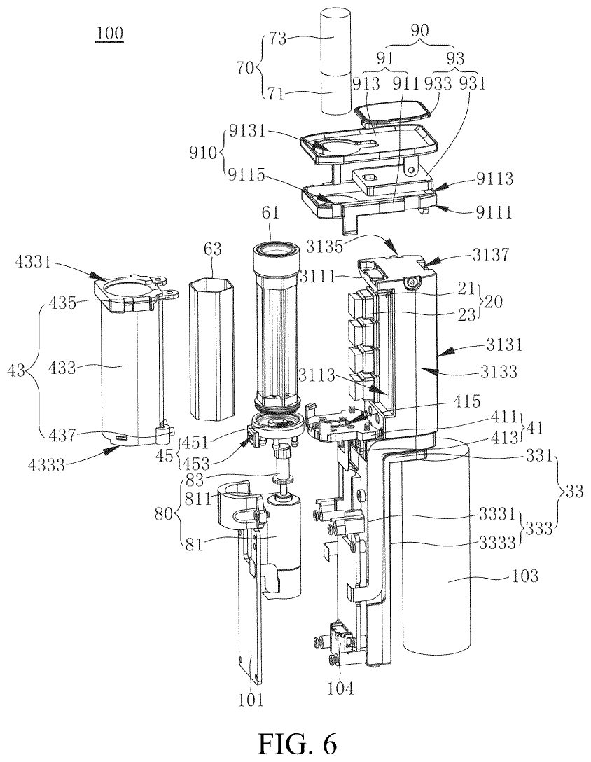

With reference to FIG. 2 and FIG. 6, in some embodiments, the first side 3131 of the abutting portion 313 is dented towards the mounting side 3111, so as to form an accommodation recess 3137. The aerosol generation device 100 may further include the function assembly 105, where the function assembly 105 is mounted in the accommodation recess 3137.

The function assembly 105 includes at least one of a button 1051 and a light emitting element 1053.

The button 1051 and the light emitting element 1053 are electrically connected to the mainboard 101. In some embodiments, the button 1051 may be used for activating the aerosol generation device 100 when pressed by the user. When the user re-presses the button 1051, the aerosol generation device 100 is deactivated. The power supply 103 may be further used for supplying power to the light emitting element 1053. The light emitting element 1053 may be used for changing a light emitting intensity, a color, etc., so as to make a reminder when the aerosol generation device 100 is activated, deactivated, or charged. With the accommodation recess 3137, space occupied by the function assembly 105 can be reduced, and the aerosol generation device 100 can be miniaturized. Moreover, a contact area between the function assembly 105 and the main body member 31 can be expanded, and a heat dissipation effect of the main body member 31 on the function assembly 105 can be improved.

Specifically, in conjunction with FIG. 5, in some embodiments, the second side 3133 of the abutting portion 313 or the third side 3135 of the abutting portion 313 is dented in the direction facing away from the side wall 11 of the housing 10, so as to form a fixing recess 3139, and the fixing recess 3139 communicates with the mounting recess 3137.

The function assembly 105 further includes a flexible circuit board 1055. The flexible circuit board 1055 is arranged in the fixing recess 3139 and connected to the function assembly 105.

One end of the flexible circuit board 1055 is electrically connected to the function assembly 105 (the button 1051 and the light emitting element 1053), and the other end thereof is electrically connected to the mainboard 101. With the fixing recess 3139, the flexible circuit board 1055 can be accommodated, a constraint and a concealing effect of the abutting portion 313 on the flexible circuit board 1055 can be improved, a connection failure between the flexible circuit board 1055 and the function assembly 105 after the flexible circuit board 1055 is deviated or bent during operation of the aerosol generation device 100 can be avoided, and the normal operation of the aerosol generation device 100 can be ensured.

Moreover, a contact area between the flexible circuit board 1055 and the main body member 31 can be expanded, and a heat dissipation effect of the main body member 31 on the flexible circuit board 1055 can be improved.

In some embodiments, the main body member 31 and the extension member 33 may be mounted in the accommodation cavity 15 through sticking, soldering, snapping, screwing, etc. Thus, the problem that during operation of the aerosol generation device 100, the aerosol generation device 100 produces a noise or the laser direction of the laser chip 23 is deviated after the main body member 31 or the extension member 33 shakes is prevented. Accordingly, the main body member 31 and the extension member 33 are connected to the housing 10, so that stability of the main body member 31 and the extension member 33 can be ensured, and no noise can be generated. Moreover, the heating efficiency of the laser chip 23 can be ensured.

In an embodiment, the heat dissipation assembly 30 may further include a heat conduction member. The heat conduction member is arranged between the housing 10 and the main body member 31. The heat conduction member is used for conducting heat of the main body member 31 to the housing 10 for heat dissipation. In some embodiments, the heat conduction member may be heat-conducting silicon grease, heat-dissipating silicon grease, a heat-conducting adhesive tape, a heat-conducting film, etc., which is not limited herein. Specifically, the heat conduction member may be arranged between the main body member 31 and the housing 10. Thus, a speed at which the heat of the main body member 31 is conducted to the housing 10 is increased, so that the heat dissipation efficiency is improved. The heat conduction member or may be arranged between the heating assembly 20 and the main body member 31. Thus, it can be ensured that the heat produced by the heating assembly 20 can be rapidly conducted to the main body member 31, so that a heat dissipation effect of the main body member 31 on the heating assembly 20 can be improved, and the normal operation of the aerosol generation device 100 can be ensured. In another embodiment, the heat conduction member is arranged between the housing 10 and the extension member 33, and the heat conduction member is used for conducting heat of the extension member 33 to the housing 10. The type of the heat conduction member is basically identical to that of the heat conduction member in the above embodiment and is not repeated herein.

With reference to FIG. 2, FIG. 3, FIG. 5, and FIG. 6, in some embodiments, the cartridge assembly 40 may include a support seat 41, a cartridge barrel 43, and a connection seat 45. The support seat 41 is mounted at the first sub-portion 331 and/or the mounting side 3111. The cartridge barrel 43 is mounted at the side, facing away from the bottom wall 13 of the housing 10, of the support seat 41. The article 60 is at least partially accommodated in the cartridge barrel 43 and used for loading the aerosol generation substrate 63.

The cartridge barrel 43 is provided with a light transmittable region 431, and the light transmittable region 431 corresponds to the laser chip 23 of the heating assembly 20.

In some embodiments, the light transmittable region 431 may be a physical light transmittable region. In other words, the light transmittable region 431 may be made of a light transmittable material such as glass and a resin. In a case that the aerosol generation substrate 63 rotates, the substrate portion 631 to be heated corresponds to the light transmittable region 431. Thus, it can be ensured that the laser emitted by the heating assembly 20 can heat the corresponding substrate portion 631 after passing through the light transmittable region 431, so that the loss of the laser on a propagation path can be reduced. In an embodiment, the cartridge barrel 43 is further provided with a non-light transmittable region 432, where the non-light transmittable region 432 is made of a light non-transmittable material. Thus, other substrate portions 631 can be prevented from being irradiated with the laser, and an amount of an aerosol generated during inhalation next time can be ensured. In another embodiment, an entire cartridge barrel 43 may be made of a light transmittable material. Thus, normal laser transmission can be ensured. Moreover, the user can observe a remaining amount of the aerosol generation substrate 63 and an aerosol generation condition through the cartridge barrel 43.

The cartridge barrel 43 may include a light transmittable region 431 and a light non-transmittable region 432. In an example, the light transmittable region 431 and the light non-transmittable region 432 may be integrally arranged. Thus, a sealing effect on the cartridge barrel 43 can be ensured, leakage of the aerosol produced after the aerosol generation substrate 63 is heated can be prevented, and the mouth feel of vaping by the user can be ensured. In another example, the light transmittable region 431 and the light non-transmittable region 432 may be separately arranged. Thus, when a light transmittable effect of the light transmittable region 431 is reduced, for example, when the light transmittable region 431 is stained, worn, or damaged, the light transmittable region 431 can be conveniently disassembled for replacement or cleaning, so that a laser transmission rate can be ensured, and the heating effect of the laser on the aerosol generation substrate 63 can be ensured.

In some embodiments, the cartridge barrel 43 includes a peripheral wall 433, one or more mounting supports 435, and one or more limiting seats 437. The peripheral wall 433 includes a first end 4331 and a second end 4333 that face away from each other. One or more mounting supports 435 extend from the first end 4331 of the peripheral wall 433 towards the main body member 31. The mounting support 435 is used for connecting the peripheral wall 433 to the main body member 31. One or more limiting seats 437 extend from the second end 4333 of the peripheral wall 433 towards the main body member 31, the limiting seat 437 partially extends into the main body member 31, and the one or more limiting seats 437 are connected to the support seat 41.

The heating assembly 20 is arranged between the peripheral wall 433 and the main body member 31, and the light transmittable region 431 is arranged at the peripheral wall 433. Thus, the laser emitted by the heating assembly 20 can heat the substrate portion 631 to be heated after passing through the peripheral wall 433. With the mounting support 435 and the limiting seat 437, stability of mounting the cartridge barrel 43 can be improved, and the noise produced after the aerosol generation device 100 shakes in a use process can be prevented. Also, the limiting seat 437 partially extends into the main body member 31. Thus, stability of the cartridge barrel 43 can be further improved, and no noise can be generated. Moreover, the cartridge barrel 43 can be located conveniently during mounting, so that an assembly speed of the aerosol generation device 100 can be improved.

It should be noted that in some embodiments, the mounting support 435 may be connected to the main body member 31, and the limiting seat 437 may be connected to the support seat 41 through screwing, snapping, etc. respectively. Thus, the aerosol generation device 100 can be convenient to assemble, and production efficiency can be improved. Moreover, when the cartridge assembly 40 or an internal device of the cartridge assembly 40 is faulty, the faulty device can be conveniently disassembled for repair or replacement.

In some embodiments, the cartridge barrel 43 may be made of aluminum alloy, stainless steel, etc. Thus, damage to the cartridge barrel 43 caused by the heat produced by the heating assembly 20 during operation can be prevented, and the normal operation of the aerosol generation device 100 can be ensured. In another embodiment, the support may be made of PC, PCTG, etc. Thus, a weight of the cartridge assembly 40 can be reduced, and the aerosol generation device 100 can be more lightweight.

With reference to FIG. 2, FIG. 3, and FIG. 6, in some embodiments, the support seat 41 includes a carrying board 411 and a protrusion 413. The protrusion 413 extends from the carrying board 411 towards the bottom wall 13 of the housing 10, and the protrusion 413 is connected to the first sub-portion 331 and/or the mounting side 3111.

The aerosol generation device 100 further includes an airflow sensor assembly 50, where the airflow sensor assembly 50 is arranged at the side, facing away from the mounting side 3111, of the protrusion 413, and the airflow sensor assembly 50 is used for detecting whether the aerosol generation device 100 is vaped.

Specifically, the cartridge barrel 43 and the protrusion 413 are located on two sides, facing away from each other, of the carrying board 411 respectively. In an example, the protrusion 413 is connected to the first sub-portion 331. In other words, the protrusion 413 is carried by the top of the first sub-portion 331. The protrusion 413 may be connected through soldering, riveting, gluing, etc. Thus, stability of the support seat 41 can be ensured. In another example, the protrusion 413 is connected to the mounting side 3111. The protrusion 413 may be connected through screwing, snapping, gluing, soldering, etc. Thus, stability of the support seat 41 can also be ensured. In yet another embodiment, the protrusion 413 is connected to the first sub-portion 331 and the mounting side 3111. The protrusion 413 may be connected to the first sub-portion 331, and the protrusion 413 may be connected to the mounting side 3111 through soldering, riveting, gluing, screwing, snapping, etc. respectively. Thus, stability of the support seat 41 is further ensured, a contact area between the support seat 41 and the heat dissipation assembly 30 is expanded, and a heat dissipation effect is improved.

The airflow sensor assembly 50 is used for detecting whether the aerosol generation device 100 is vaped. When the aerosol generation device 100 is vaped, the airflow sensor assembly 50 can output a signal to the mainboard 101, and the mainboard 101 controls the heating assembly 20 to be activated according to the signal, so that the heating assembly 20 heats the corresponding substrate portion 631; and when the aerosol generation device 100 is not vaped, the airflow sensor assembly 50 can output a signal to the mainboard 101, and the mainboard 101 controls the heating assembly 20 to stop heating according to the signal; where the above steps are performed cyclically. It should be noted that in some embodiments, the airflow sensor assembly 50 can output a signal to the mainboard 101 according to a strength of vaping the aerosol generation device 100, so that the mainboard 101 controls the heating assembly 20 to increase or decrease the heating power.

With reference to FIG. 2, FIG. 3, and FIG. 6, in some embodiments, the cartridge assembly 40 and the housing 10 jointly form a device air passage 110, and the airflow sensor assembly 50 includes an electrical connector 51 and an airflow sensor 53. The electrical connector 51 is arranged the side, facing away from the mounting side 3111, of the protrusion 413.

The airflow sensor 53 is arranged at the electrical connector 51. The electrical connector 51 is provided with a through hole 511 communicating with the device air passage 110. The airflow sensor 53 covers the through hole 511. The electrical connector 51 is used for connecting the airflow sensor 53 to the mainboard 101. The airflow sensor 53 is used for determining whether the aerosol generation device 100 is vaped according to an air pressure in the device air passage 110.

In conjunction with FIG. 5, specifically, when the user performs vaping, the air pressure in the device air passage 110 gradually decreases relative to an external air pressure, so as to form a negative pressure. The airflow sensor assembly 50 detects a change in air pressure in the device air passage 110, so as to determine that the aerosol generation device 100 is in a vaped state. Thus, the airflow sensor assembly 50 delivers the signal to the mainboard 101, and the mainboard 101 controls the heating assembly 20 to be activated, so as to heat the corresponding substrate portion 631. When the user stops vaping, external air enters the device air passage 110, so that an air pressure in the device air passage 110 is identical to the external air pressure. The airflow sensor assembly 50 detects that the air pressure in the device air passage 110 returns to a positive pressure, so as to determine that the aerosol generation device 100 is in a non-vaped state. Thus, the airflow sensor assembly 50 sends the signal to the mainboard 101, and the mainboard 101 controls the heating assembly 20 to stop heating.

In some embodiments, sealing members/a sealing member may be arranged between the airflow sensor 53 and the electrical connector 51 and/or between the electrical connector 51 and the device air passage 110. With the sealing member, leakage of air in the device air passage 110 can be prevented, and accuracy of detecting the air pressure in the device air passage 110 by the airflow sensor 53 can be ensured, so that the normal operation of the aerosol generation device 100 can be ensured.

In some embodiments, the side wall 11 of the housing 10 is provided with a penetrated-through air inlet hole 111, and the cartridge assembly 40 further includes a connection seat 45 mounted at the support seat 41. The support seat 41 is provided with a first channel 415, the connection seat 45 is provided with a second channel 451 and a communication hole 453 corresponding to and communicating with the air inlet hole 111, and the second channel 451, the first channel 415, the communication hole 453, and the air inlet hole 111 communicate with one another in sequence, so as to jointly form the device air passage 110.

The external air can enter the aerosol generation device 100 through the air inlet hole 111, so that the air pressure in the device air passage 110 is identical to the external air pressure. Specifically, when the user performs vaping, an air pressure in the device air passage 110 gradually decreases to form a negative pressure. The airflow sensor assembly 50 detects a change in air pressure in the device air passage 110, so as to deliver a signal to the mainboard 101, and the mainboard 101 controls the heating assembly 20 to be activated, so as to heat the corresponding substrate portion 631. When the user stops vaping, external air enters the device air passage 110 through the air inlet hole 111, so that an air pressure in the device air passage 110 is identical to the external air pressure. The airflow sensor assembly 50 detects that the air pressure in the device air passage 110 returns to a positive pressure, so as to determine that the aerosol generation device 100 is in a non-vaped state. Thus, the airflow sensor assembly 50 sends a signal to the mainboard 101, and the mainboard 101 controls the heating assembly 20 to stop heating.

In some embodiments, the connection seat 45 and the support seat 41 of the cartridge assembly 40 are attached to each other. In other words, the bottom of the connection seat 45 is attached to the top of the support seat 41. Thus, leakage of the air in the device air passage 110 can be prevented, and accuracy of detecting the air pressure in the device air passage 110 by the airflow sensor assembly 50 can be ensured. Moreover, corrosion to the drive assembly 80 or another function assembly after the aerosol generated flows out of the device air passage 110 can be prevented, and the normal operation of the drive assembly 80 or another function assembly can be ensured.

With reference to FIG. 2 and FIG. 3, in some embodiments, the article 60 includes a support member 61 and the aerosol generation substrate 63. The support member 61 is at least partially accommodated in the cartridge barrel 43 of the cartridge assembly 40. The extension direction (the length direction) of the support member 61 is basically identical to the extension direction (the length direction) of the main body member 31. The support member 61 rotates relative to the support seat 41. The aerosol generation substrate 63 is arranged around the support member 61, and the aerosol generation substrate 63 is accommodated in the cartridge barrel 43. In a case that the support member 61 rotates, the aerosol generation substrate 63 rotates along with the support member 61.

In conjunction with FIG. 5, the support member 61 may be made of a material resistant to a high temperature, for example, a polyetheretherketone (PEEK) material, a high-melting-point metal, and a high-temperature-resistant ceramic, which is not limited herein. The aerosol generation substrate 63 is arranged around the support member 61 and corresponds to the heating assembly 20. In a case that the support member 61 rotates the cartridge assembly 40 at first, the aerosol generation substrate 63 rotates along with the support member 61, so that the heating assembly 20 can correspond to different substrate portions 631.

The extension direction of the support member 61 is basically identical to the extension direction of the main body member 31. Thus, the distance between one or more laser chips 23 and the aerosol generation substrate 63 can be substantially the same. Thus, different positions of the corresponding substrate portion 631 can be heated by the laser chip 23 uniformly, and the aerosol generation efficiency can be ensured. Moreover, space occupied by the article 60 and the heat dissipation assembly 30 can also be reduced, and the aerosol generation device 100 can be miniaturized.

In some embodiments, the aerosol generation device 100 further includes a mouthpiece 70. The support member 61 includes a loading portion 611, a support frame 613, and a connection portion 615. The mouthpiece 70 passes through the loading portion 611, and the loading portion 611 is at least partially located outside the cartridge barrel 43. The support frame 613 is connected to the loading portion 611. The support frame 613 is located in the cartridge barrel 43. The aerosol generation substrate 63 is arranged around the support frame 613. The loading portion 611 communicates with the support frame 613. The connection portion 615 is connected to the support frame 613, and the connection portion 615 is closer to the bottom wall 13 of the housing 10 than the support frame 613. The connection portion 615 is detachably connected to the connection seat 45 of the cartridge assembly 40.

In some embodiments, the connection portion 615 may be rotatably and hermetically connected to the connection seat 45. For example, a sealing ring is arranged between the connection portion 615 and the connection seat 45. Thus, normal rotation of the article 60 can be ensured. The heating assembly 20 can correspond to different substrate portions 631, so that freshness of the aerosol generated by the aerosol generation substrate 63 during inhalation by the user each time can be ensured, and the mouth feel of vaping can be improved. In some embodiments, the connection seat 45 may be made of a material resistant to a high temperature, such as polyetheretherketone (PEEK), silicone rubber, etc. Thus, damage (for example, deformation) to the connection seat 45 under the action of the heat is prevented, and the normal operation of the aerosol generation device 100 is ensured.

In some embodiments, the mouthpiece 70 includes a cooling segment 71 and a filtering segment 73, where the cooling segment 71 communicates with the filtering segment 73. The cooling segment 71 passes through the loading portion 611. The filtering segment 73 is located at one end, facing away from the loading portion 611, of the cooling segment 71. The filtering segment 73 is at least partially located outside the accommodation cavity 15.

In some embodiments, the cooling segment 71 communicates with the filtering segment 73. The user can take an inspiration at the filtering segment 73, so as to inhale the aerosol generated into the mouth. When passing through the cooling segment 71, the aerosol has a temperature decreased, so that the user is prevented from inhaling an overhot aerosol. The filtering segment 73 can filter away some impurities, so as to prevent the user from inhaling the impurities into the mouth. Thus, the mouth feel of vaping by the user can be improved.

In some embodiments, the filtering segment 73 includes a porous member, such as cotton and a porous ceramic, which is not limited herein. The porous member facilitates circulation of the air and the aerosol, and has a desirable adsorption capability. Thus, adsorption of the impurities in airflow is facilitated, and the user is prevented from inhaling the impurities into the mouth. In some embodiments, the cooling segment 71 includes a polylactic acid material. The polylactic acid material has a desirable heat absorption capability. Thus, it is ensured that a temperature of the aerosol that has passed through the cooling segment 71 is not too high.

In some embodiments, the cooling segment 71 may be mounted at the loading portion 611 in an interference fit manner. Thus, sealing performance between the mouthpiece 70 and the article 60 is ensured, and leakage of the aerosol is prevented, so that the amount of the aerosol to be inhaled by the user can be ensured, and further the mouth feel of the vaping can be ensured.

With reference to FIG. 2, FIG. 3, and FIG. 5, in some embodiments, the support member 61 and the aerosol generation substrate 63 jointly form a plurality of article air passages 120, each substrate portion 631 is used to delimit one article air passage 120, and the device air passage 110 of the aerosol generation device 100 communicates with an article air passage 120 delimited by a substrate portion 631 currently heated constantly.

Specifically, when the user performs vaping via the mouthpiece 70, an air pressure in the device air passage 110 gradually decreases relative to an external air pressure, so as to form a negative pressure. The airflow sensor assembly 50 detects a change in air pressure in the device air passage 110, so as to determine that the aerosol generation device 100 is in a vaped state. Thus, the mainboard 101 controls the heating assembly 20 to heat the corresponding substrate portion 631, so as to generate an aerosol, and the aerosol generated is inhaled by the user through the article air passage 120. When the user stops vaping, external air enters the device air passage 110 through the air inlet hole 111, so that an air pressure in the device air passage 110 is identical to the external air pressure. The airflow sensor assembly 50 detects that the air pressure in the device air passage 110 is changed back to a positive pressure, so as to determine that the aerosol generation device 100 is in a non-vaped state. Thus, the mainboard 101 controls the heating assembly 20 to stop heating the corresponding substrate portion 631. Moreover, the mainboard 101 controls the drive assembly 80 to drive the article 60 to rotate, so that the heating assembly 20 corresponds to a next substrate portion 631. Thus, the aerosol generation device 100 can be stopped immediately after vaping, and user experience can be improved.

With reference to FIG. 2 and FIG. 3, in some embodiments, the loading portion 611 is provided with a penetrated-through hole 6111, the support frame 613 is provided with a plurality of airflow channels 6131, the connection portion 615 is provided with a plurality of penetration holes 6151, each airflow channel 6131 corresponds to one penetration hole 6151 and the penetrated-through hole 6111, and each airflow channel 6131, the penetrated-through hole 6111, and the corresponding penetration hole 6151 form one article air passage 120.

Specifically, in conjunction with FIG. 5, the support frame 613 cooperates with the aerosol generation substrate 63, so as to form the plurality of airflow channels 6131. Different substrate portions 631 each correspond to one airflow channel 6131. In an embodiment, the loading portion 611 is provided with one penetrated-through hole 6111. The penetrated-through hole 6111 communicates with the plurality of airflow channels 6131. The airflow channels 6131 correspond one-to-one to the penetration holes 6151. Thus, each airflow channel 6131, the penetrated-through hole 6111, and the corresponding penetration hole 6151 form one article air passage 120. The mouthpiece 70 passes through the loading portion 611 and communicates with the plurality of penetrated-through holes 6111. In other words, the mouthpiece 70 communicates with the plurality of article air passages 120. With one penetrated-through hole 6111, a processing technology of the loading portion 611 can be simplified, and production efficiency of the support frame 613 can be improved. In another embodiment, the loading portion 611 is provided with a plurality of penetrated-through holes 6111 corresponding to different substrate portions 631. The connection portion 615 is provided with a plurality of penetration holes 6151 corresponding to different substrate portions 631. The penetrated-through hole 6111, the airflow channel 6131, and the penetration hole 6151 correspond one-to-one to one another, so as to form one article air passage 120. The mouthpiece 70 passes through the loading portion 611 and communicates with the plurality of penetrated-through holes 6111. In other words, the mouthpiece 70 communicates with the plurality of article air passages 120. With the plurality of penetrated-through holes 6111, the aerosol generated can be prevented from entering another article air passage 120 through an adjacent penetrated-through hole 6111. Thus, the amount of the aerosol to be inhaled by the user is ensured, and further the mouth feel of the vaping is ensured.

In some embodiments, a stop member is arranged at the outer side of the aerosol generation substrate 63, and the stop member is used for stopping the aerosol generated by the aerosol generation substrate 63 from flowing to the laser chip 23. The stop member may be made of tin paper or another light transmittable material. The stop member is attached to the outer side of the aerosol generation substrate 63. When the heating assembly 20 heats the corresponding substrate portion 631, the heat can pass through the stop member, and thus the corresponding substrate portion 631 is heated, so as to generate the aerosol. With the stop member, corrosion to the heating assembly 20 and other components after the aerosol generated leaks out of the article air passage 120 can be prevented, and the normal operation of the aerosol generation device 100 can be ensured. Moreover, the amount of the aerosol to be inhaled by the user can be ensured, and further the mouth feel of vaping can be ensured.

In some embodiments, the drive assembly 80 includes a drive member 81 and a connection component 83. The drive member 81 is electrically connected to the mainboard 101.

The connection component 83 passes through the cartridge assembly 40, an output shaft 811 of the drive member 81 is connected to the article 60 through the connection component 83, and the drive member 81 is used for driving the article 60 to rotate relative to the cartridge assembly 40.

Specifically, the output shaft 811 of the drive assembly 80 is connected to the connection portion 615 of the article 60 through the connection component 83. The drive member 81 is used for allowing the drive assembly 80 to rotate relative to the cartridge assembly 40. Thus, the heating assembly 20 corresponds to different substrate portions 631. In a case of vaping the aerosol generation device 100, the heating assembly 20 heats the substrate portion 631 currently corresponding to the heating assembly. In a case that the aerosol generation device 100 stops being vaped, the output shaft 811 of the drive member 81 rotates, so as to drive the article 60 to rotate relative to the cartridge assembly 40. Thus, the heating assembly 20 corresponds to the next substrate portion 631. In some embodiments, the drive member 81 may be an electric motor.

In some embodiments, one or more first channels 415 may be provided in the support seat 41. One or more first channels 415 are spaced from the connection component 83. Thus, corrosion to the connection component 83 by the aerosol generated by the aerosol generation substrate 63 can be prevented, and the normal operation of the drive assembly 80 can be ensured. In an example, the support seat 41 may be internally provided with one or more first channels 415, and the first channel 415 communicates with the communication hole 453 and the air inlet hole 111, so as to form the device air passage 110. Thus, the first channel 415 is arranged inside the support seat 41. Thus, sealing performance of the device air passage 110 can be further ensured, and accuracy of detecting the air pressure in the device air passage 110 by the airflow sensor assembly 50 can be ensured. In another example, one or more first channels 415 may be provided on the surface of the side, facing the connection seat 45, of the support seat 41, and the first channel 415 communicates with the communication hole 453 and the air inlet hole 111, so as to form the device air passage 110. The first channel 415 is provided on the surface of the side, facing the connection seat 45, of the support seat 41. Thus, a processing technology of the support seat 41 can be simplified, and a production speed of the support seat 41 can be increased. In yet another example, one or some of a plurality of first channels 415 are provided inside the support seat 41, and remaining first channels are provided on the surface of the side, facing the connection seat 45, of the support seat 41.

With reference to FIG. 2, FIG. 4, FIG. 5, and FIG. 6, in some embodiments, the top of the housing 10 is provided with an opening 17. The aerosol generation device 100 further includes a cover assembly 90. The cover assembly 90 includes a fixed component 91 and a movable component 93. The fixed component 91 is fixedly mounted in the opening 17 and provided with a penetrated-through plug-in hole 910, and the plug-in hole 910 communicates with the accommodation cavity 15. The movable component 93 is mounted at the fixed component 91, and the movable component 93 is movable relative to the fixed component 91, so as to selectively open or cover the plug-in hole 910.

The top of the housing 10 is provided with the opening 17. In other words, the side, facing away from the bottom wall 13 of the housing 10, of the accommodation cavity 15 is provided with the opening 17.

The cover assembly 90 covers the opening 17, so as to protect the device in the accommodation cavity 15. Thus, external dust, sewage, etc. are prevented from entering the accommodation cavity 15, and internal cleaning of the aerosol generation device 100 and normal operation of the internal device are ensured. When the aerosol generation device 100 is in use, the movable component 93 moves relative to the fixed component 91, so as to open the plug-in hole 910. Thus, the mouthpiece 70 passes through the plug-in hole 910, so as to communicate with the article air passage 120. When the aerosol generation device 100 is not in use, the mouthpiece 70 may be taken out of the plug-in hole 910, and the movable component 93 moves relative to the fixed component 91, so as to cover the plug-in hole 910. Thus, external dust, sewage, etc. are prevented from entering the accommodation cavity 15.

In some embodiments, the fixed component 91 includes a first cover member 911 and a second cover member 913. The first cover member 911 includes a first side 9111 and a second side 9113 that face away from each other, and a first penetration hole 9115 penetrating the first side 9111 and the second side 9113. The first side 9111 of the first cover member 911 faces the bottom wall 13 of the housing 10. The first cover member 911 covers the opening 17 and is fixedly connected to the cartridge assembly 40 and/or the main body member 31. The second cover member 913 is arranged at the second side 9113 of the first cover member 911, and the first cover member 911 cooperates with the second cover member 913, so as to form a movement recess 920. The second cover member 913 includes a penetrated-through second penetration hole 9131, where the second penetration hole 9131 corresponds to the first penetration hole 9115, so as to form the plug-in hole 910, and the second cover member 913 is fixedly connected to the cartridge assembly 40 and/or the main body member 31.

In a case that the first cover member 911 is connected to the main body member 31, the first cover member 911 can be connected to the second side 3133 of the abutting portion 313 and the third side 3135 of the abutting portion 313. Thus, stability of covering the opening 17 with the first cover member 911 can be ensured. Moreover, the first cover member 911 can further be connected to the first side 3131 of the abutting portion 313. Thus, deviation of the first cover member 911 when the movable component 93 moves relative to the fixed component 91 can be prevented, and stability of mounting the cover assembly 90 can be ensured.

In some embodiments, the movable component 93 includes a movable member 931 and a force application member 933. The movable member 931 is accommodated in the movement recess 920 and movable relative to the fixed component 91 in the movement recess 920. The force application member 933 is arranged at the side, facing away from the first cover member 911, of the second cover member 913. The force application member 933 is connected to the movable member 931. The force application member 933 is used for driving the movable member 931 to move along relative to the fixed component 91, so as to cover or open the plug-in hole 910.

In some embodiments, the movable member 931 may be provided with a roller. Correspondingly, the bottom wall or the side wall of the movement recess 920 may be provided with a sliding recess. When the movable member 931 is arranged in the movement recess 920, the sliding recess cooperates with the roller, so that the movable member 931 is movable relative to the fixed component 91, so as to cover or open the plug-in hole 910. In another embodiment, the movable member 931 may move in the movement recess 920 in other common cooperation manners, for example, cooperation between a sliding block and a sliding rail, which is not repeated herein.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol generation device, comprising:
a housing comprising a side wall and a bottom wall, an accommodation cavity being jointly delimited by the side wall of the housing and the bottom wall of the housing;
a heating assembly accommodated in the accommodation cavity, the heating assembly being configured to emit a laser to heat an aerosol generation substrate; and
a heat dissipation assembly accommodated in the accommodation cavity, the heat dissipation assembly comprising a main body member, the main body member comprising a mounting portion and an abutting portion,
wherein the heating assembly is mounted at the mounting portion, and
wherein the abutting portion is closer to the side wall of the housing than the mounting portion so as to dissipate heat from the heating assembly.

2. The aerosol generation device of claim 1, wherein the abutting portion abuts against an inner side of the side wall of the housing.

3. The aerosol generation device of claim 1, wherein the aerosol generation substrate comprises a cylindrical structure, and
wherein an emergent direction of the laser is substantially perpendicular to an extension direction of the aerosol generation substrate.

4. The aerosol generation device of claim 1, wherein the mounting portion comprises a mounting side,
wherein the abutting portion comprises a first side, a second side, and a third side,
wherein the first side of the abutting portion faces away from the mounting side,
wherein the second side of the abutting portion faces away from the third side of the abutting portion, and
wherein the mounting side, the second side of the abutting portion, the first side of the abutting portion, and the third side of the abutting portion are connected in sequence.

5. The aerosol generation device of claim 4, wherein the mounting side is dented towards the first side of the abutting portion so as to form a mounting recess, and
wherein the heating assembly comprises:
a circuit board arranged in the mounting recess; and
one or more laser chips mounted at the circuit board, the one or more laser chips being configured to emit the laser.

6. The aerosol generation device of claim 4, wherein the first side of the abutting portion is dented towards the mounting side so as to form an accommodation recess, and
wherein the aerosol generation device comprises:
a function assembly mounted in the accommodation recess, the function assembly comprising at least one of a button and a light emitting element.

7. The aerosol generation device of claim 6, wherein the mounting side is dented towards the first side of the abutting portion so as to form a mounting recess,
wherein the second side of the abutting portion or the third side of the abutting portion is dented in the direction facing away from the side wall of the housing so as to form a fixing recess, the fixing recess communicating with the mounting recess, and
wherein the function assembly further comprises:
a flexible circuit board arranged in the fixing recess and connected to the function assembly.

8. The aerosol generation device of claim 1, wherein the heat dissipation assembly comprises:
an extension member extending from a bottom of the main body member to a bottom wall of the housing and connected to the bottom wall of the housing, the extension member being configured to conduct heat produced by the heating assembly to the housing.

9. The aerosol generation device of claim 8, wherein the heat dissipation assembly comprises a heat conduction member, and
wherein the heat conduction member is arranged between the housing and the main body member, and the heat conduction member is configured to conduct heat of the main body member to the housing, and/or the heat conduction member is arranged between the housing and the extension member, and the heat conduction member is configured to conduct heat of the extension member to the housing.

10. The aerosol generation device of claim 8, wherein the extension member comprises:
a first sub-portion extending from the bottom of the main body member to the side at which the heating assembly is located; and
a second sub-portion extending from a bottom of the first sub-portion towards the bottom wall of the housing, and
wherein the first sub-portion, the second sub-portion, and the main body member form a Z-shaped structure.

11. The aerosol generation device of claim 10, wherein the second sub-portion comprises a first side and a second side that face away from each other, and
wherein the aerosol generation device comprises a mainboard mounted a the first side of the second sub-portion.

12. The aerosol generation device of claim 11, further comprising:
a drive assembly mounted at the first side of the second sub-portion, the drive assembly being electrically connected to the mainboard.

13. The aerosol generation device of claim 12, wherein the aerosol generation substrate comprises a plurality of substrate portions distributed in a peripheral direction, wherein the aerosol generation device further comprises a cartridge assembly and an article,
wherein the cartridge assembly is mounted at the first sub-portion and/or the mounting side of the mounting portion,
wherein the article is at least partially accommodated in the cartridge assembly configured to load the aerosol generation substrate, and
wherein the drive assembly is configured to drive the article to rotate relative to the cartridge assembly so as to enable the heating assembly to correspond to different substrate portions of the plurality of substrate portions.

14. The aerosol generation device of claim 13, wherein the cartridge assembly comprises:
a support seat mounted at the first sub-portion and/or the mounting side; and
a cartridge barrel mounted at a side of the support seat facing away from the bottom wall of the housing,
wherein the article is at least partially accommodated in the cartridge barrel, the cartridge barrel being provided with a light transmittable region, the light transmittable region corresponding to a laser chip of the heating assembly.

15. The aerosol generation device of claim 13, wherein the article comprises:
a support member at least partially accommodated in a cartridge barrel of the cartridge assembly, an extension direction of the support member being substantially identical to an extension direction of the main body member, the support member being configure to rotate relative to a support seat of the cartridge assembly; and
the aerosol generation substrate arranged around the support member, the aerosol generation substrate being accommodated in the cartridge barrel, and
wherein the aerosol generation substrate is configured to rotate along with the support member upon rotation of the support member.

16. The aerosol generation device of claim 15, wherein the support member and the aerosol generation substrate jointly form a plurality of article air passages,
wherein each substrate portion is configured to delimit one article air passage, and
wherein a device air passage of the aerosol generation device communicates with an article air passage delimited by a substrate portion currently heated constantly.

17. The aerosol generation device of claim 15, further comprising:
a mouthpiece,
wherein the support member comprises:
a loading portion, the mouthpiece passing through the loading portion, the loading portion being at least partially located outside the cartridge barrel;
a support frame connected to the loading portion, the support frame being located in the cartridge barrel, the aerosol generation substrate being arranged around the support frame, the loading portion communicating with the support frame; and
a connection portion connected to the support frame, the connection portion being closer to the bottom wall of the housing than the support frame, the connection portion being detachably connected to a connection seat of the cartridge assembly.

18. The aerosol generation device of claim 17, wherein the loading portion is provided with a penetrated-through hole,
wherein the support frame is provided with a plurality of airflow channels,
wherein the connection portion is provided with a plurality of penetration holes,
wherein each airflow channel of the plurality of airflow channels corresponds to one penetration hole of the plurality of penetration holes and the penetrated-through hole, and
wherein each airflow channel, the corresponding penetration hole, and the corresponding penetrated-through hole form an article air passage.

19. The aerosol generation device of claim 17, wherein the mouthpiece comprises a cooling segment and a filtering segment,
wherein the cooling segment communicates with the filtering segment,
wherein the cooling segment passes through the loading portion,
wherein the filtering segment is located at one end of the cooling segment facing away from the loading portion, and
wherein the filtering segment is at least partially located outside the accommodation cavity.

20. The aerosol generation device of claim 15, wherein a stop member is provided at an outer side of the aerosol generation substrate, the stop member being configured to stop an aerosol generated by the aerosol generation substrate from flowing to a laser chip.
